(19) United States
(12) Patent Application Publication
(10) Pub. No.: US 2012/0205459 A1
(43) Pub. Date: Aug. 16, 2012

(54) ROAD SPRAY SYSTEM AND METHOD

(75) Inventors: Willliam Bebb, Kearney, NE (US); Randy Kline, Greeley, CO (US)

(73) Assignee: ENVIROTECH SERVICES, INC., Greeley, CO (US)

(21) Appl. No.: 13/271,967

(22) Filed: Oct. 12, 2011

Related U.S. Application Data
(60) Provisional application No. 61/441,608, filed on Feb. 10, 2011.

(51) Int. Cl. B05B 9/00

(52) U.S. Cl. 239/1; 239/289

(57) ABSTRACT

A method of operating a road spray system for distributing a liquid is provided. The method involves determining a degraded status of a road based on road condition information received from a road condition sensor. In response to determining the degraded status, a spray command is transmitted to valve control modules. The spray command is addressed to a selected one of the valve control modules and transmitted over electrical conductors which supply power to the valve control modules. The method also includes determining, at one of the valve control modules, that the one valve control module is the selected valve control module and activating a valve associated with the selected valve control module permitting flow of the liquid through the valve to a spray nozzle. Finally, the method also includes the step of receiving status information from the selected valve control module over the electrical conductors.

### TECHNICAL FIELD

Various embodiments of the present invention relate generally to distribution of liquids. More specifically, various embodiments of the present invention relate to operation and control of an automated road spray system.

### BACKGROUND

A large portion of the earth's population lives in climates where freezing conditions occur. In colder climates, slick roads are responsible for large numbers of accidents, injury, and property damage. Roads have been traditionally de-iced by spreading salt, sometimes mixed with sand or gravel for increased traction. Sodium chloride is often used as it is inexpensive and widely available, but it has limitations in that its effectiveness diminishes at temperature below zero degrees Fahrenheit. Sodium chloride also causes significant corrosion problems in automobiles and certain construction materials.

More recently, other types of salts, such as calcium chloride and magnesium chloride, have become commonly used for de-icing roads. Many other variations and combinations of chemicals are used, including some which produce an exothermic reaction in addition to lowering the freezing point of the water on the road. Many of these road treatments are mixed and applied to roads in liquid form. These road treatments are sometimes sprayed on roads which are already icy or snow covered to melt the ice or snow and break the bond between the ice or snow and the road. In addition, these road treatments are sometimes preemptively sprayed on roads when slick and/or freezing conditions are expected in order to stop the freezing or bonding before it occurs.

Once applied, these road treatments do not work indefinitely. They must be periodically reapplied to maintain their effectiveness. While use of trucks with spray mechanisms is an effective means of application in many cases, application is limited by the number of trucks and drivers available, as well as other factors. For this and other reasons, permanent or semi-permanent spray systems are sometimes installed at problematic locations. These systems are capable of periodically applying road treatments without dispatching a truck and driver to those locations and, often, without having personnel onsite to operate the system. Bridges and overpasses are often the most susceptible to ice, snow, and freezing conditions and often good candidates for these types of permanent or semi-permanent road spray systems.

In addition to the problems of snow and ice, road treatments are also sometimes applied in a similar manner for other purposes. For example, road treatments may also be applied for dust control, erosion control, or soil stabilization.

### SUMMARY

While multiple embodiments are disclosed, still other embodiments of the present invention will become apparent to those skilled in the art from the following detailed description, which shows and describes illustrative embodiments of the invention. As will be realized, the invention is capable of modifications in various aspects, all without departing from the scope of the present invention. Accordingly, the drawings and detailed description are to be regarded as illustrative in nature and not restrictive.

In some embodiments, a method of operating a road spray system for distributing a liquid is provided. The method involves determining a degraded status of a road based, at least in part, on road condition information received from a road condition sensor. In response to determining the degraded status of the road, a spray command is transmitted to valve control modules. The spray command is addressed to a selected one of the valve control modules and transmitted over electrical conductors which supply power to the valve control modules. The method also includes the step of determining, at one of the valve control modules, that the one valve control module is the selected valve control module and activating a valve. Activation of the valve permits flow of the liquid through the valve to a spray nozzle. Finally, the method also includes the step of receiving status information from the selected valve control module over the electrical conductors.

In some embodiments the liquid is an anti-icing fluid or a de-icing fluid.

In some embodiments, the valve control modules are collocated with at least one valve and at least one spray nozzle at one of several spray coverage areas of the road.

In some embodiments, the valve control modules are serially connected using the electrical conductors.

In some embodiments, the road condition sensor performs a non-invasive optical measurement on the road to generate road condition information.

In some embodiments, the non-invasive optical measurement is a measurement of the depth of snow, the thickness of ice, or road friction.

In some embodiments, the road condition sensor is a temperature sensor.

In some embodiments, the method also includes the step of monitoring electrical current associated with the activation of the valve and updating a valve operation indicator based on the electrical current.

In some embodiments, the spray command includes a spray duration period and activating the valve includes opening the valve for the spray duration period.

In some embodiments, the method also includes determining the end of the spray duration period and transmitting a second spray command to the valve control modules over the electrical conductors in order to open a second valve associated with a second spray nozzle.

In some embodiments, the method also includes activating a road sign associated with the road in response to determining the degraded status of the road.

In some embodiments, activating the road sign includes transmitting a road sign activation command over the electrical conductors.

In some embodiments, the method includes transmitting the spray command in response to receiving an input from an operator of the road spray system.

In some embodiments, the operator input is received through a telephone connection, a web page, a network connection, a text message, or a wireless communications receiver.

### BRIEF DESCRIPTION OF THE DRAWINGS

Embodiments of the present invention will be described and explained through the use of the accompanying drawings.

FIG. 1 illustrates an example of an operating environment in which some embodiments of the present invention may be utilized.

FIG. 2 illustrates an example of a road spray system.

FIG. 3 is a flow chart illustrating a set of exemplary operations for operating a road spray system in accordance with some embodiments of the present invention.

FIG. 4 is a flow chart illustrating a set of exemplary operations for operating a road spray system containing multiple zones in accordance with some embodiments of the present invention.

FIG. 5 is a block diagram illustrating exemplary components which can be included in a road spray controller.

FIG. 6 illustrates an example of a computer system with which some embodiments of the present invention may be utilized.

The drawings have not necessarily been drawn to scale. For example, the dimensions of some of the elements in the figures may be expanded or reduced to help improve the understanding of the embodiments of the present invention. Similarly, some components and/or operations may be separated into different blocks or combined into a single block for the purposes of discussion of some of the embodiments of the present invention. Moreover, while the invention is amenable to various modifications and alternative forms, specific embodiments have been shown by way of example in the drawings and are described in detail below. The intention, however, is not to limit the invention to the particular embodiments described. On the contrary, the invention is intended to cover all modifications, equivalents, and alternatives falling within the scope of the invention as defined by the appended claims.

### DETAILED DESCRIPTION

Various embodiments of the present invention relate generally to distribution of liquids. More specifically, various embodiments of the present invention relate to operation and control of an automated road spray system.

In the following description, for the purposes of explanation, numerous specific details are set forth in order to provide a thorough understanding of embodiments of the present invention. It will be apparent, however, to one skilled in the art that embodiments of the present invention may be practiced without some of these specific details.

Road treatments of various types are often applied to roadways in liquid form. Road treatments are often used for anti-icing, de-icing, dust control, soil stabilization, and erosion control. Road treatments are sometimes sprayed on roads to remedy existing conditions and are sometimes sprayed on roads to preemptively deal with expected or possible conditions. Once applied, these road treatments do not work indefinitely; they must be periodically reapplied to maintain their effectiveness. While use of trucks with spray mechanisms can be an effective means of application, this approach is limited by the number of trucks and drivers available, the location of the trucks and drivers, as well as budgetary concerns. For these and other reasons, permanent or semi-permanent spray systems are sometimes installed at problematic road locations.

Using these systems, a road treatment is periodically sprayed through nozzles at fixed locations to treat the road surface. These systems alleviate the need to drive a truck to the location for each treatment and can be operated remotely in some cases. These systems are also capable of repeatedly applying road treatments without dispatching a truck and driver to those locations for each application. These systems are typically divided into zones or sections which are each associated with a different section or stretch of the road. Each of the zones or sections typically have one or more electrically controlled valves which control flow of the liquid road treatment to that zone or section.

Because the spray zones described above often span significant physical distances, one or more disadvantages are typically encountered. In one situation, valves are located at or near each of the spray zones. In this case, additional electrical wiring must be installed between a central control point and each of the valves. Depending on the distance, additional equipment may be needed to properly transmit signals over these distances. The additional wiring often results in additional installation, maintenance, and troubleshooting costs. In the second situation, all of the valves are at the central location. In this case, runs of fluid piping associated with each valve must be installed between the central location and the location of the nozzles. Each of these additional segments of piping may need to extend for significant distances. This approach also results in significant additional installation, maintenance, and troubleshooting costs.

The present invention provides a road spray system which uses multiple valve control modules. A processor transmits commands to the valve control modules in order to open certain valves, thereby spraying the specified sections of road. The commands are broadcast to all of the valve control modules in the system over the same distributed electrical conductors which provide power to the valve control modules. Each valve control module individually parses the commands and activates one or more valves if it is the addressee of the command. In this way, a single processor can control many valves spread over large distances without the complexity, cost, or problems associated with additional electrical control lines, parallel piping, or wireless links. Communication with the valve control modules can occur over the single set of electrical conductors which are already needed to provide power to various components of the system.

Although many of the examples of the present invention provided herein are described with respect to a road spray system for distributing anti-icing liquids, these examples are in no way meant to be limiting. One skilled in the art will understand that the invention may be applied to road spray systems for other purposes and for distribution of other types of liquids. The invention is intended to cover all implementations falling within the scope of the invention as defined by the appended claims. In the following descriptions, for the purposes of explanation, numerous specific details are set forth in order to provide a thorough understanding of the embodiments of the present invention. It will be apparent, however, to one skilled in the art that embodiments of the present invention may be practiced without some of these specific details.

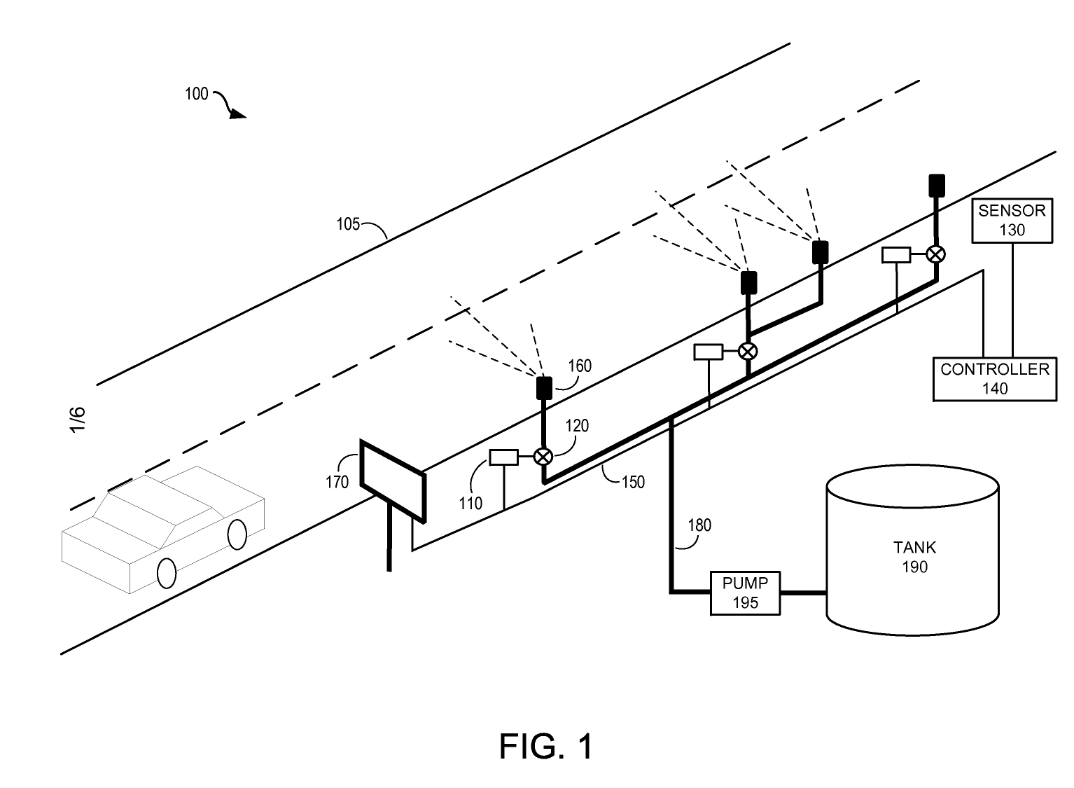

Having described embodiments of the present invention generally, attention is directed to FIG. 1 which illustrates operating environment 100 in which some embodiments of the present invention may be utilized. Operating environment 100 includes road 105, valve control module 110, valve 120, sensor 130, controller 140, electrical conductor 150, nozzle 160, sign 170, liquid distribution line 180, tank 190, and pump 195.

Nozzle 160 is any type of device for controlling the distribution of a liquid onto the surface of road 105. Typically, nozzle 160 is designed to break up the flow of the liquid into drops or droplets in order to disperse a relatively small amount of the liquid over a relatively large area as well as disperse it across a coverage area. Nozzle 160 may be made up of multiple components and may have some moving components as well. Each of the other nozzles in operating environment may be of the same design as nozzle 160 or may have different characteristics to accomplish different needs of the area of road 105 which each covers.

Valve 120 is any type of device which controls or regulates the flow of a gas or liquid. In this case, valve 120 is an electrically controlled valve which regulates the flow of a liquid from liquid distribution line 180 to nozzle 160. Valve 120 may be a normally-open or normally-closed valve and may also be capable of regulating the amount of liquid flowing to nozzle 160 in addition to having fully open and fully closed states. While valve 120 controls flow of the liquid to only nozzle 160 in this example, a single valve will often control flow of liquid to multiple nozzles.

Liquid is supplied to valve 120, and other valves and devices in the system, by pump 195 through liquid distribution line 180. Pump 195 draws liquid from tank 190 and supplies it to the valves and nozzles at a specified flow rate and pressure. The combination of pump 195 and liquid distribution line 180 are not capable of maintaining the specified pressure beyond a certain flow rate. Designated flow rates and pressures are needed for the proper operation of the nozzles. If the designated flow rate is exceeded, the pressure will typically drop below an acceptable level. For this reason, all of the valves and nozzles in a system typically cannot be operated simultaneously. The valves and nozzles must be operated in groups or zones in order to not overburden the liquid supply capabilities of pump 195 and/or liquid distribution line 180. A zone may include a single valve, multiple valves, a single nozzle, multiple nozzles, or some combination thereof.

In other configurations, tank 190 may be installed at an elevated location such that gravity provides the necessary liquid pressure and pump 195 may be unnecessary. Also, the liquid may be supplied from some other type of pressurized or regulated source outside of operating environment 100 such that pump 195 and tank 190 may both be unnecessary.

Valve 120 is controlled by valve control module 110. Valve control module 110 may be any set of electronic devices or components which translate an electrical signal received over electrical conductor 150 into signals which control the operation of valve 120. In some examples, valve control module 110 controls multiple valves. In other examples, valve control module 110 and valve 120 may be integrated into a single unit.

Electrical conductor 150 is a set of conductors which provide electrical power to the valve control modules. More specifically, conductor 150 is used to supply power from controller 140 to valve control module 110, and potentially to other devices in the system. This power may be supplied in a wide range of voltages including, 12VDC, 24VDC, 24VAC, 120VAC, 240VAC, or potentially other voltages. While electrical conductor 150 may be referred to in the singular sense, it is typically a grouping of two or more wires for distributing electricity. In the case of direct current, electrical conductor 150 may include a positive and a negative lead. In the case of alternating current, it may include a “hot” lead, a neutral lead, and possibly a ground. Additional conductors may also be included in electrical conductor 150.

In addition to power, data or data signals are simultaneously transmitted from controller 140 to valve control module 110 over electrical conductor 150. This is accomplished through power line communication. Power line communication is also sometimes referred to as power line carrier (PLC), Power line Digital Subscriber Line (PDSL), mains communication, power line telecom (PLT), power line networking (PLN), or Broadband over Power Lines (BPL). Some examples of devices which can be used to implement this type of communication over power lines are the PL3120/3150/3170 family of power line transceivers manufactured by the Echelon Corporation. As illustrated, electrical conductor 150 is connected to multiple devices in operating environment 110, including multiple valve control modules like valve control module 110.

Sensor 130 performs a measurement of road 105 or the conditions around road 105. Sensor 130 may be a temperature sensor, humidity sensor, a dust sensor, optical sensor, infrared sensor, or sensor of another type. In some examples, sensor 130 is embedded in road 105. In other cases, sensor 130 is a non-invasive optical infrared sensor capable of determining a grip/friction reading or a thickness of water, ice, or snow on road 105. Sensor 130 may also monitor traffic on the road in order to make determinations regarding when the road should be sprayed. Sensor 130 may also be a combination of these types of sensors. Although one sensor is illustrated, many sensors may be used, including distributed use in different areas of road 105.

Based on the information received from sensor 130, and possibly information from other sensor or data sources, controller 140 uses an algorithm to determine the status of road 105, or portions of road 105. If controller 140 determines that the road is sufficiently degraded and/or other conditions are met, controller 140 selects which of the nozzles should be activated to spray road 105 with an appropriate liquid. Based on the selected nozzles, controller 140 transmits a spray command in order to activate one or more valves associated with those nozzles. The spray command is addressed to a valve control module associated with the valve or valves. The spray command is transmitted over the same electrical conductors supplying power to the valve control modules.

In one example, a single set of electrical conductors is used to supply power to all of the valve control modules in the system. The valve control modules are serially connected to each other by electrical conductor 150. Therefore, when controller 140 sends the spray command, it is received by all of the valve control modules in the system in a broadcast fashion. The spray command is specifically addressed to one or more of the valve control modules in the system even though it is received by all of them. Each valve control module is capable of receiving and parsing the spray command to determine if it is the intended recipient or target of the command.

In one example, the spray command is addressed to valve control module 110 and not the other valve control modules in the system. After receiving the spray command and making this determination, valve control module 110 activates valve 120 to spray the liquid onto road 105 through nozzle 160. In some cases, the command may be addressed to two or more valve control modules which activate their associated valves simultaneously.

It should be understood that the spray command may also contain other types of information and instructions. For example, the spray command may also contain a duration for which valve control module 110 should activate valve 120. In this case, valve control module 110 manages the timing and deactivates valve 120 at the appropriate time rather than requiring another command or signal from controller 140 to deactivate valve 120.

In another example, valve 120 is a variable valve and the spray command includes information indicating a proportional activation of valve 120. The proportion could be indicated as a percentage, a flow rate, a coverage distance, or some other parameter. In addition, nozzle 160 may be positionable or have other variable features. The spray command to valve control module 110 may contain further information resulting in the control of these features of nozzle 160.

Valve control module 110 may also be configured to transmit status information over conductor 150 to controller 140, to the other valve control modules, or to some combination thereof. Status information may include information about the state or operation of valve control module 110, the state or operation of valve 120, or other information. For example, valve control module 110 may have the capability to monitor the proper operation of valve 120 by monitoring how much current is consumed by valve 120 when it is activated or by monitoring a flow or liquid through the valve. Valve control module 110 may determine an operational status of valve 120 based on one of these methods and communicate status information regarding the operation of the valve to controller 140. Controller 140 may use this information to assess the health of the system, provide an alert, or take alternate steps to provide spray coverage using another nozzle.

In addition, other devices in the system may be capable of utilizing the power and/or communication capabilities of electrical conductor 150. For example, sign 170 is a road sign which warns drivers when degraded conditions of road 105 are detected. Controller 140 not only provides power to sign 170 over conductor 150 but can send commands to sign 170 over conductor 150. Sign 170 contains electronics similar to those of valve control module 110 which allow it to parse and interpret command messages. Controller 140 may not only control whether sign 170 is activated but may also control the message displayed on sign 170.

In other examples, valve control module 110 may receive data from other sensors or information sources which are not directly linked to controller 140. In these cases, valve control module 110 may communicate this information to controller 140 or other devices in the system in a manner similar to that described above. For example, additional road sensors may distributed along road 105 at locations near the valve control modules. Information from these sensors may be collected by the valve control modules rather than running additional electrical wiring from controller 140 to each of these additional sensors.

The road spray system in FIG. 1 enables a controller to power and control multiple spray locations, or groups of spray locations, from a central location through use of a single liquid distribution line and a single electrical conductor.

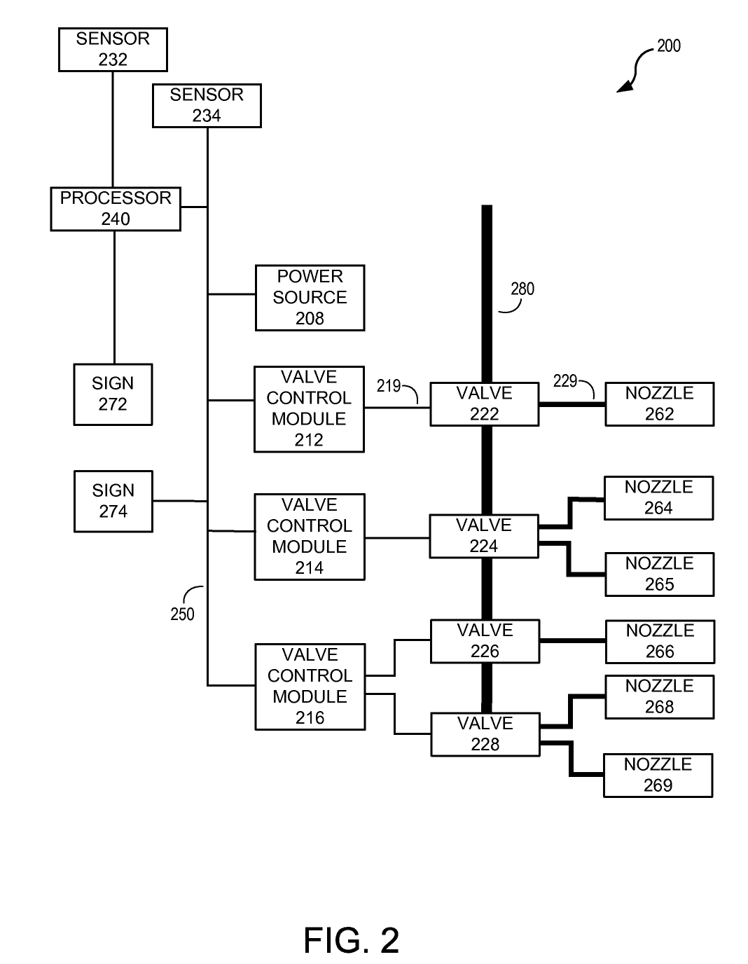

FIG. 2 illustrates road spray system 200. Road spray system 200 is one example of the road spray system illustrated in operational environment 100 although other configurations and operations are possible. In road spray system 200, nozzles 262-269 are used to spray a liquid onto a road surface. Although no distinction is made between nozzles 262-269 in FIG. 2, each of the nozzles could be a different one of many different types of liquid distribution devices.

Nozzles 262-269 are supplied a pressurized liquid from liquid distribution line 280 by one of valves 222-228. For example, nozzle 262 is supplied liquid from liquid distribution line 280 by valve 222 through liquid connection 229. Valves 222-228 are examples of valve 120 although their configuration and operation may vary. Each of valves 222-228 is electrically actuated by one valve control modules 212-216. For example, valve 222 is electrically actuated through electrical connection 219 by valve control module 212. Valve 222 may be a normally-closed valve and only require an electrical signal through electrical connection 219 to be placed into an open state. Valve 222 may also be a normally-open valve and only require an electrical signal to be placed into a closed state. Alternately, valve 222 may switch states on a command basis and remain in its present state until another command is received even though no power is being applied through electrical connection 219.

Valve control modules 212-216 are powered by power source 208 through power line 250. Power source 208 may supply power in the form of direct current or alternating current. Power line 250 comprises two or more electrical conductors and is an example of electrical conductor 150. Processor 240 performs control processes for road spray system 240 by sending commands over power line 250. Processor 240 is an example of controller 140 although processor 240 may be configured or operate in an alternate manner. Processor 240 may or may not draw its own operating power from power line 250.

Sensors 232 and 234 are used to monitor the condition of a road. Sensors 232 and 234 are examples of sensor 130 although sensors 232 and 234 may have alternate features or operate in alternate manners. Processor 240 receives road condition information from sensor 232 through a dedicated connection. This dedicated connection may also be a wireless connection. Processor 240 receives road condition information from sensor 234 over power line 250. This information is transmitted over the power conductors in a manner similar to that used for the communication between processor 240 and the valve control modules.

Signs 272 and 274 are used to display warnings or other information regarding road conditions to users of the road. As with the sensors, one of the signs is connected to processor 240 through a dedicated connection while the other communicates with processor 240 over power line 250. It should be understood that other devices which contribute to the operation of road spray system 200 may be added to the system and communicate with the system over power line 250 in a similar manner.

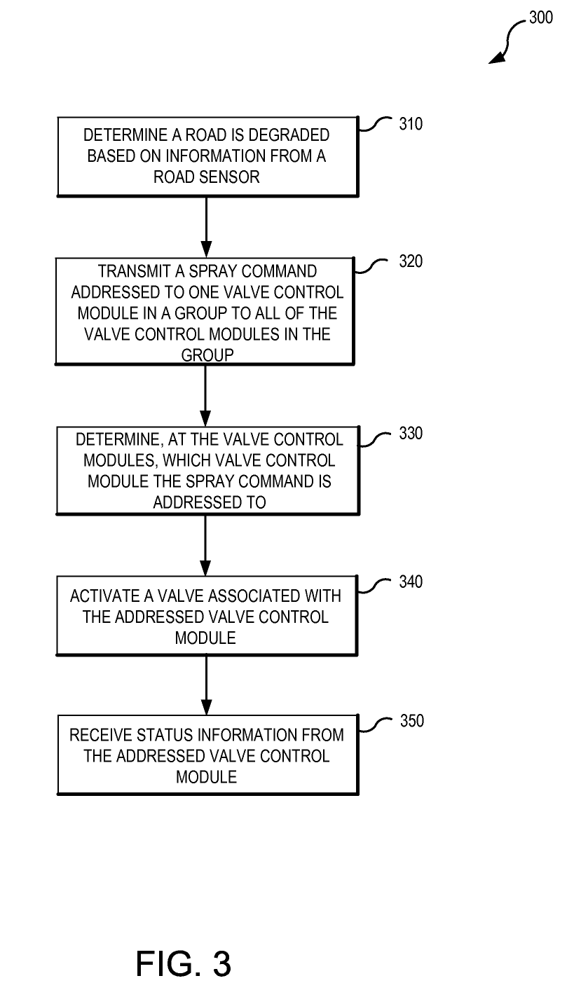

FIG. 3 is a flow chart illustrating method 300 of operating a road spray system for distributing a liquid. In step 310, a road is determined to have a degraded status based on information from one or more road sensors. Based on the degraded status, a spray command is transmitted (step 320). The spray command is transmitted to a group of valve control modules over the electrical power conductors which supply power to those valve control modules. However, the spray command is addressed to only one of those valve control modules. At step 330, the valve control modules receive the spray command and determine which valve control module the command is addressed to. The valve control module which is addressed in the spray command then activates a valve in order to spray the liquid through the associated nozzle (step 340). During or after activation of the valve, status information is received from the valve control module over the electrical power conductors (step 350). Method 300 may be implemented in operating environment 100, road spray system 200, or another system with similar features.

In a variation of method 300, the spray command is transmitted at step 320 in response to an input from an operator of the system. The response may be based on the input of the operator alone or the input of the operator in conjunction with road condition information from one or more of the sensors. The operator may be present at the site of the system or may be providing the input from a remote location. In some cases, the operator may be providing this input through a telephone connection, a web page, a text message, a network connection, or a wireless connection. Multiple road spray systems may be networked to a single website allowing an operator to monitor or control multiple systems through a single website or control system.

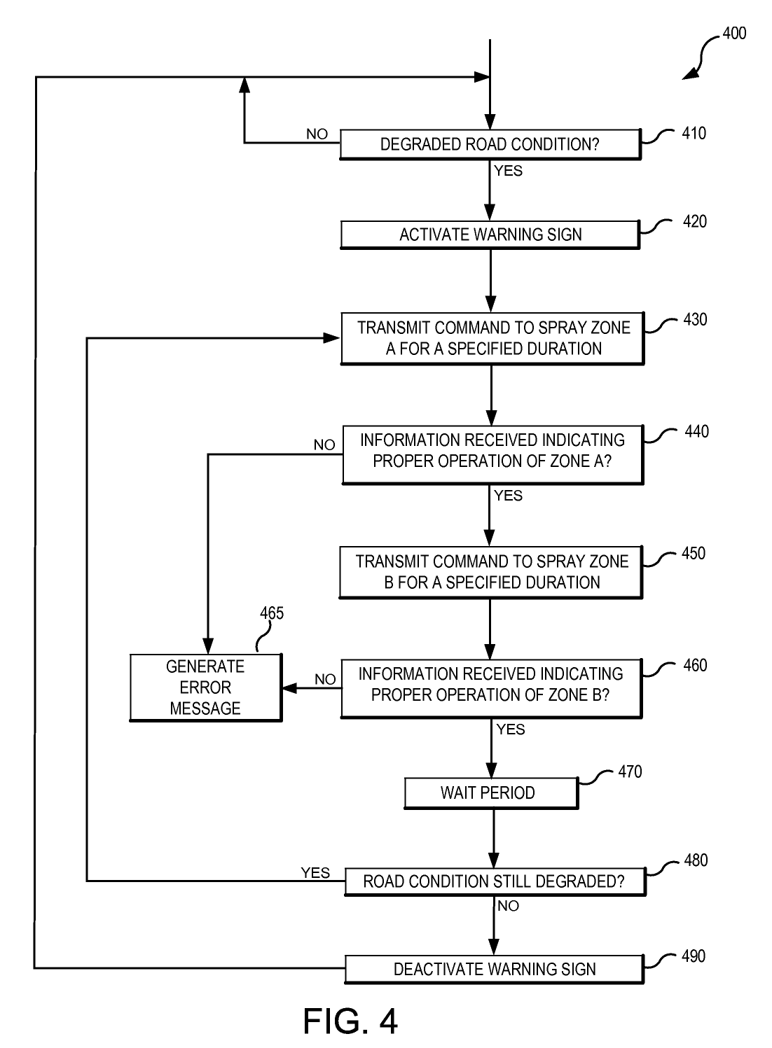

FIG. 4 is a flow chart illustrating method 400 for operating a road spray system with multiple spray zones in accordance with some embodiments of the present invention. The spray zones cover different areas of a road, different stretches of a road, or different areas of a collection of roads. In some cases, different zones are required because the system is not capable of supplying a high enough rate of liquid flow and/or pressure to simultaneously operate all of the spray zones. Consequently, a large area of road may have to be sprayed by successively operating different zones of the spray system which make up the larger area. In the example of method 400, only two zones, zones A and B, are discussed. However, many more zones are possible. Method 400 may be used separately or in conjunction with any of the methods or system of FIGS. 1-3.

In method 400, a warning sign is activated when a degraded road condition is detected (steps 410-420). A centralized processor or controller transmits a command to spray zone A for a specified period of time (step 430). This command is transmitted to all of the valve control modules in the system or to a group of valve control modules to which the command may be applicable. Each of the valve control modules receives and processes the command. The valve control module for zone A determines that the command applies to it and activates the valve or valves associated with zone A for the specified time period.

The valve control modules are also capable of determining if the valves are operating correctly. This may be done by monitoring the flow of electrical current to the valve when the valve is activated, monitoring the flow liquid through the valve, monitoring a pressure, or by other means. Based on this information, the valve control module transmits a message indicating whether the spraying of zone A was successful (step 440). If the spraying was not successful, an error message is generated at step 465. If a message is received indicating that zone A operated correctly, a command is sent to operate zone B for a specified period of time (step 450). The proper operation of zone B is reported in a similar manner at step 460. Zone A and zone B may have different durations because they are in different locations, have different types of nozzles, have different numbers of nozzles, are associated with different terrain, cover different parts of the road, or have different operational characteristics.

It should be understood that there are other possible responses to the error message at 465. In some cases, a road spray system may be operating in locations where someone is not readily available to repair the system or assess the malfunction in response to the error message. Consequently, once an error message is generated, method 400 may include a command to reattempt operation of the failed zone or may proceed to operation of the next zone in the sequence. In some examples, the determination as to whether to reattempt operation of a failed zone may be based, at least in part, on monitoring of pressures and/or flow rates.

At step 470, after each of the applicable zones has been operated, the system waits a specified period of time before reassessing the road condition. The duration of the wait period may be based on one or more factors including: an expected time for the liquid sprayed on the road to take affect, a limitation on how much of the liquid can be applied to the road in a given period of time, the condition of the road, a quantity of liquid remaining in the tank, or other factors. After the wait period, a determination is made as to whether the road condition is still degraded (step 480). If the road is still degraded the spray process repeats starting at zone A. If the road conditions are no longer degraded, the warning sign is deactivated (step 490).

In other examples, the condition of the road may be assessed in individual segments associated with each of the zones. Certain zones may be operated based on those individual assessments while other zones are not operated. In a further variation, the zones may each be operated for variable durations based on the individual assessments.

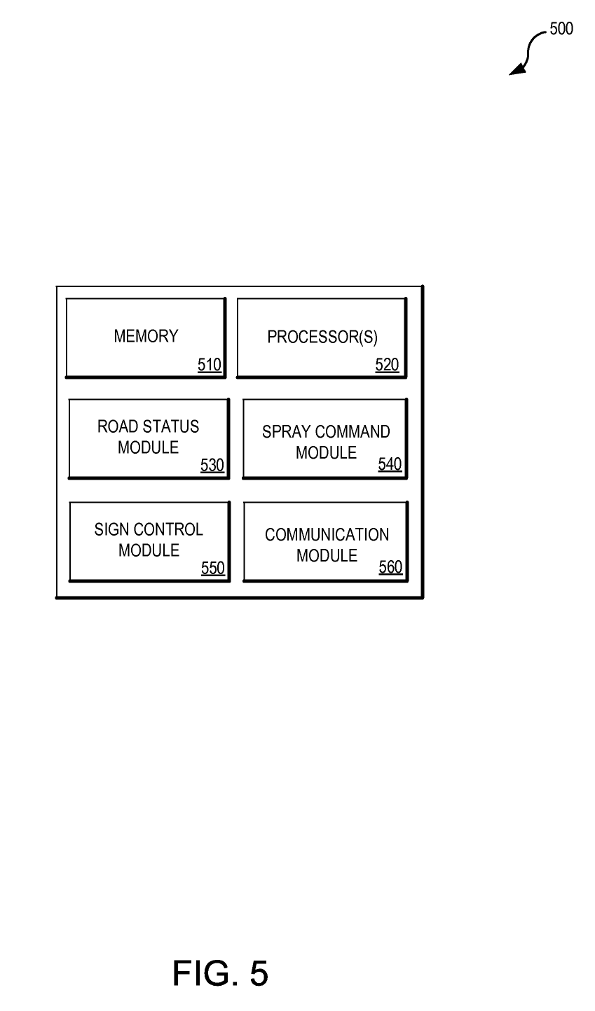

FIG. 5 is a block diagram illustrating exemplary modules which may be included in road spray controller 500 in accordance with various embodiments of the present invention. Road spray controller 500 is one example of controller 140 or processor 240. According to the embodiments shown in FIG. 5, road spray controller 500 can include memory 510, one or more processors 520, road status module 530, spray command module 540, sign control module 550, and communication module 560. Other embodiments of the present invention may include some, all, or none of these modules along with other modules, applications, and/or components. Still yet, some embodiments may incorporate two or more of these modules into a single module and/or associate a portion of the functionality of one or more of these modules with a different module.

For example, in one embodiment, the functionality associated with road status module 530 and spray command module 540 can be integrated into a single spray control module. In another example, road status module 530 can be separated into a sensor interface module and a sensor data processing module.

Memory 510 can be any device, mechanism, or populated data structure used for storing information. In accordance with some embodiments of the present invention, memory 510 can encompass any type of, but is not limited to, volatile memory, nonvolatile memory, and dynamic memory. For example, memory 510 can be random access memory, memory storage devices, optical memory devices, media magnetic media, floppy disks, magnetic tapes, hard drives, SIMMs, SDRAM, DIMMs, RDRAM, DDR RAM, SODIMMS, erasable programmable read-only memories (EPROMs), electrically erasable programmable read-only memories (EEPROMs), compact disks, DVDs, and/or the like. In accordance with some embodiments, memory 510 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information which can be used as memory 510.

Memory 510 may be used to store instructions for running one or more applications or modules on processor(s) 520. For example, memory 510 could be used in one or more embodiments to house all or some of the instructions needed to execute the functionality of any combination of modules 530-560.

Road status module 530 is configured to determine a status of one or more roads based, at least in part, on road condition information received from one or more sensors. Spray command module 540 is configured to generate and transmit spray commands to one or more valve control modules. The spray commands are transmitted through communication module 560. Communication module 560 may contain circuitry allowing commands or data to be transmitted to other devices in the system over electrical conductors which are also used to carry power to those other devices. In addition, communication module 560 may be configured to receive commands from an operator of the system. Communication module 560 may contain interfaces enabling communication in many formats including: telephone, wireless, Internet, network, email, text message, or others. Sign control module 550 is configured to control or operate one or more warning signs associated with the road in response to the condition of the road. Sign control module 550 may also communicate with the signs through communication module 560.

Exemplary Computer System Overview:

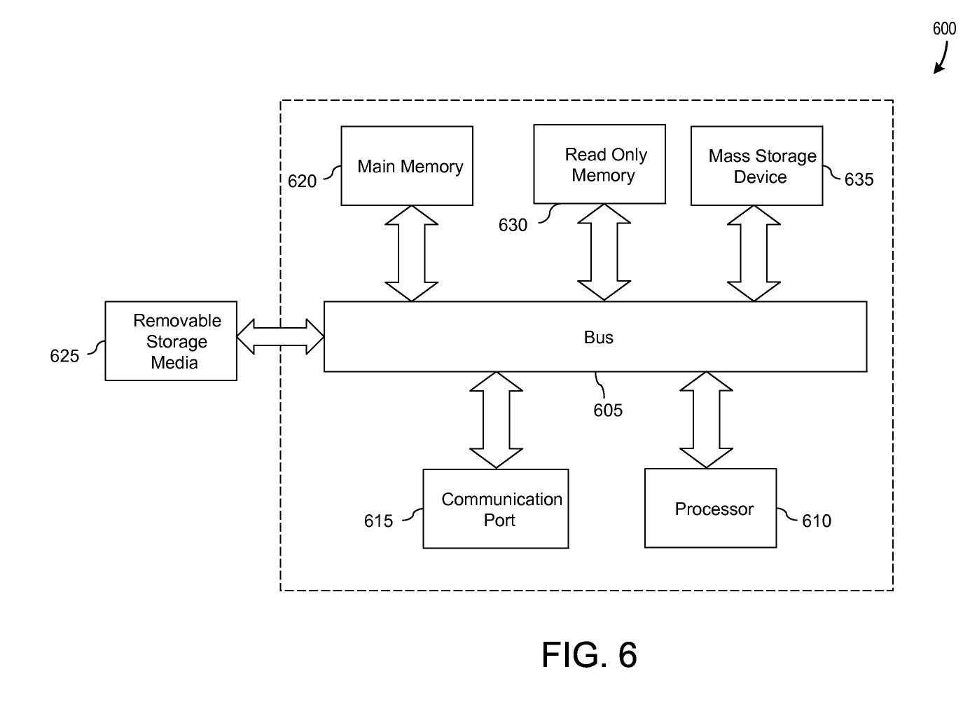

Embodiments of the present invention include various steps and operations, which have been described above. A variety of these steps and operations may be performed by hardware components or may be embodied in machine-executable instructions, which may be used to cause a general-purpose or special-purpose processor programmed with the instructions to perform the steps. Alternatively, the steps may be performed by a combination of hardware, software, and/or firmware. As such, FIG. 6 is an example of a computer system 600 with which embodiments of the present invention may be utilized. According to the present example, the computer system includes a bus 605, at least one processor 610, at least one communication port 615, a main memory 620, a removable storage media 625, a read only memory 630, and a mass storage 635.

Processor 610 can be any known processor, such as, but not limited to, an Intel® Itanium® or Itanium 2® processor(s), or AMD® Opteron® or Athlon MP® processor(s), or Motorola® lines of processors. Communication port(s) 615 can be any of an RS-232 port for use with a modem based dialup connection, a 10/100 Ethernet port, or a Gigabit port using copper or fiber. Communication port(s) 615 may be chosen depending on a network such a Local Area Network (LAN), Wide Area Network (WAN), or any network to which the computer system 600 connects.

Main memory 620 can be Random Access Memory (RAM), or any other dynamic storage device(s) commonly known in the art. Read only memory 630 can be any static storage device(s) such as Programmable Read Only Memory (PROM) chips for storing static information such as instructions for processor 610.

Mass storage 635 can be used to store information and instructions. For example, hard disks such as the Adaptec® family of SCSI drives, an optical disc, an array of disks such as RAID, such as the Adaptec family of RAID drives, or any other mass storage devices may be used.

Bus 605 communicatively couples processor 610 with the other memory, storage and communication blocks. Bus 605 can be a PCI/PCI-X or SCSI based system bus depending on the storage devices used.

Removable storage media 625 can be any kind of external hard-drives, floppy drives, IOMEGA® Zip Drives, Compact Disc—Read Only Memory (CD-ROM), Compact Disc—Re-Writable (CD-RW), Digital Video Disk—Read Only Memory (DVD-ROM).

The components described above are meant to exemplify some types of possibilities. In no way should the aforementioned examples limit the scope of the invention, as they are only exemplary embodiments.

Terminology:

Brief definitions of terms, abbreviations, and phrases used throughout this application are given below.

The terms “connected” or “coupled” and related terms are used in an operational sense and are not necessarily limited to a direct physical connection or coupling. Thus, for example, two devices may be coupled directly, or via one or more intermediary media or devices. As another example, devices may be coupled in such a way that information can be passed therebetween, while not sharing any physical connection with one another. Based on the disclosure provided herein, one of ordinary skill in the art will appreciate a variety of ways in which connection or coupling exists in accordance with the aforementioned definition.

The phrases “in some embodiments,” “according to some embodiments,” “in the embodiments shown,” “in other embodiments,” “in some examples,” and the like generally mean the particular feature, structure, or characteristic following the phrase is included in at least one embodiment of the present invention, and may be included in more than one embodiment of the present invention. In addition, such phrases do not necessarily refer to the same embodiments or different embodiments.

If the specification states a component or feature “may”, “can”, “could”, or “might” be included or have a characteristic, that particular component or feature is not required to be included or have the characteristic.

The term “responsive” includes completely or partially responsive.

The term “module” refers broadly to a software, hardware, or firmware (or any combination thereof) component. Modules are typically functional components that can generate useful data or other output using specified input(s). A module may or may not be self-contained. An application program (also called an “application”) may include one or more modules, or a module can include one or more application programs.

The term “network” generally refers to a group of interconnected devices capable of exchanging information. A network may be as few as several personal computers on a Local Area Network (LAN) or as large as the Internet, a worldwide network of computers. As used herein “network” is intended to encompass any network capable of transmitting information from one entity to another. In some cases, a network may be comprised of multiple networks, even multiple heterogeneous networks, such as one or more border networks, voice networks, broadband networks, financial networks, service provider networks, Internet Service Provider (ISP) networks, and/or Public Switched Telephone Networks (PSTNs), interconnected via gateways operable to facilitate communications between and among the various networks.

Embodiments of the present invention may be provided as a computer program product which may include a machine-readable medium having stored thereon instructions which may be used to program a computer (or other electronic devices) to perform a process. The machine-readable medium may include, but is not limited to, floppy diskettes, optical disks, compact disc read-only memories (CD-ROMs), and magneto-optical disks, ROMs, random access memories (RAMs), erasable programmable read-only memories (EPROMs), electrically erasable programmable read-only memories (EEPROMs), magnetic or optical cards, flash memory, or other type of media/machine-readable medium suitable for storing electronic instructions. Moreover, embodiments of the present invention may also be downloaded as a computer program product, wherein the program may be transferred from a remote computer to a requesting computer by way of data signals embodied in a carrier wave or other propagation medium via a communication link (e.g., a modem or network connection).

While, for convenience, embodiments of the present invention are described with reference to spraying an anti-icing fluid on a road, embodiments of the present invention are equally applicable to application of various other liquids. The examples are in no way meant to be limiting. The invention is intended to cover all implementations falling within the scope of the invention as defined by the appended claims.

Also, for the sake of illustration, various embodiments of the present invention have herein been described in the context of computer programs, physical components, and logical interactions within modern computer networks. Importantly, while these embodiments describe various aspects of the invention in relation to modern computer networks and programs, the method and apparatus described herein are equally applicable to other systems, devices, and networks as one skilled in the art will appreciate. As such, the illustrated applications of the embodiments of the present invention are not meant to be limiting, but instead exemplary. Other systems, devices, and networks to which embodiments of the present invention are applicable include, but are not limited to, other types of communication and computer devices and systems.

In conclusion, the present invention provides novel systems, methods, and arrangements for systems and methods for operating a road spray system. While detailed descriptions of one or more embodiments of the invention have been given above, various alternatives, modifications, and equivalents will be apparent to those skilled in the art without varying from the spirit of the invention. For example, while the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof. Therefore, the above description should not be taken as limiting the scope of the invention, which is defined by the appended claims.

What is claimed is:

1. A method of operating a road spray system for distributing a liquid comprising:
determining a degraded status of a road based, at least in part, on road condition information received from a road condition sensor;
in response to determining the degraded status, transmitting a spray command to a plurality of valve control modules, wherein:
the spray command is addressed to a selected one of the plurality of valve control modules; and
the spray command is transmitted over electrical conductors which supply power to the plurality of valve control modules;
determining, at one of the plurality of valve control modules, that the one valve control module is the selected valve control module;
activating a valve associated with the selected valve control module permitting flow of the liquid through the valve to a spray nozzle; and
receiving status information from the selected valve control module over the electrical conductors.

2. The method of claim 1 wherein the liquid is one of an anti-icing fluid or a de-icing fluid.

3. The method of claim 1 wherein each of the plurality of valve control modules is collocated with at least one valve and at least one spray nozzle at one of a plurality of coverage areas of the road.

4. The method of claim 3 wherein the plurality of valve control modules are serially connected using the electrical conductors.

5. The method of claim 1 wherein the road condition sensor performs a non-invasive optical measurement on the road to generate the road condition information.

6. The method of claim 5 wherein the non-invasive optical measurement comprises measurement of one of the group of: a depth of snow, a depth of ice, and a road friction.

7. The method of claim 1 wherein the road condition sensor comprises a temperature sensor.

8. The method of claim 1 further comprising monitoring electrical current associated with the activation of the valve and updating a valve operation indicator based on the electrical current.

9. The method of claim 1 wherein:
the spray command comprises a spray duration period; and
activating the valve comprises opening the valve for the spray duration period.

10. The method of claim 1 further comprising:
determining the end of the spray duration period; and
transmitting a second spray command to the plurality of valve control modules over the electrical conductors in order to open a second valve associated with a second spray nozzle.

11. The method of claim 1 further comprising activating a road sign associated with the road further in response to determining the degraded status.

12. The method of claim 11 wherein activating the road sign comprises transmitting a road sign activation command over the electrical conductors.

13. The method of claim 1 further comprising transmitting the spray command in response to receiving an input from an operator of the road spray system.

14. The method of claim 13 wherein the input is received through one of the group of: a telephone connection, a web page, a network connection, a text message, and a wireless communications receiver.

15. A non-transitory computer readable medium comprising instructions which, when executed by a processor, direct the processor to perform a method of operating a road spray system comprising:
determining a degraded status of a road based, at least in part, on road condition information received from a road condition sensor;
in response to determining the degraded status, transmitting a spray command to a plurality of valve control modules, wherein:
the spray command is addressed to a selected one of the plurality of valve control modules; and
the spray command is transmitted over electrical conductors which supply power to the plurality of valve control modules;
determining, at one of the plurality of valve control modules, that the one valve control module is the selected valve control module;
activating a valve associated with the selected valve control module permitting flow of a liquid through the valve to a spray nozzle; and
receiving status information from the selected valve control module over the electrical conductors.

16. The computer readable medium of claim 15 wherein the liquid is one of an anti-icing fluid or a de-icing fluid.

17. The computer readable medium of claim 15 wherein each of the plurality of valve control modules is collocated with at least one valve and at least one spray nozzle at one of a plurality of coverage areas of the road.

18. The computer readable medium of claim 17 wherein the plurality of valve control modules are serially connected using the electrical conductors.

19. The computer readable medium of claim 15 wherein the road condition sensor performs a non-invasive optical measurement on the road to generate the road condition information.

20. The computer readable medium of claim 19 wherein the non-invasive optical measurement comprises measurement of one of the group of: a thickness of snow, a thickness of ice, and an estimation of road friction.

21. The computer readable medium of claim 15 wherein the road condition sensor comprises a temperature sensor.

22. The computer readable medium of claim 15 further comprising monitoring electrical current associated with the activation of the valve and updating a valve operation indicator based on the electrical current.

23. The computer readable medium of claim 15 wherein:
the spray command comprises a spray duration period; and activating the valve comprises opening the valve for the spray duration period.

24. The computer readable medium of claim 15 further comprising:
determining the end of the spray duration period; and
transmitting a second spray command to the plurality of valve control modules over the electrical conductors in order to open a second valve associated with a second spray nozzle.

25. The computer readable medium of claim 15 further comprising activating a road sign associated with the road further in response to determining the degraded status.

26. The computer readable medium of claim 15 wherein activating the road sign comprises transmitting a road sign activation command over the electrical conductors.

27. The computer readable medium of claim 15 further comprising transmitting the spray command in response to receiving an input from an operator of the road spray system.

28. The computer readable medium of claim 27 wherein the input is received through one of the group of: a telephone connection, a web page, a network connection, a text message, and a wireless communications receiver.

29. A road spray system for distributing a liquid on a road comprising:
a plurality of valve control modules;
a plurality of valves;
a road condition sensor; and
a processor configured to:
determine a degraded status of the road based, at least in part, on road condition information received from the road condition sensor;
in response to the degraded status, transmit a spray command to the plurality of valve control modules, wherein:
the spray command is addressed to a selected one of the plurality of valve control modules; and
the spray command is transmitted over electrical conductors which supply power to the plurality of valve control modules; and
receive status information from the plurality of valve control modules over the electrical conductors;
wherein, in response to receiving the spray command, the selected valve control module is configured to activate a valve of the plurality of valves thereby permitting flow of the liquid to a spray nozzle.

30. The road spray system of claim 29 wherein the liquid is one of an anti-icing fluid or a de-icing fluid.

31. The road spray system of claim 29 wherein each of the plurality of valve control modules is associated with and located at a separate coverage area of the road.

32. The road spray system of claim 30 wherein the plurality of valve control modules are serially connected using the electrical conductors.

33. The road spray system of claim 29 wherein the road condition sensor performs a non-invasive optical measurement on the road to generate the road condition information.

34. The road spray system of claim 33 wherein the non-invasive optical measurement comprises measurement of one of the group of: a depth of snow, a thickness of ice, and a road friction.

35. The road spray system of claim 29 wherein the road condition sensor comprises a temperature sensor.

36. The road spray system of claim 29 wherein the addressed valve control module is configured to monitor electrical current associated with the activation of the valve and update a valve operation indicator based on the electrical current.

37. The road spray system of claim 29 wherein:
the spray command comprises a spray duration period; and
the valve is activated for the spray duration period.

38. The road spray system of claim 29 wherein the processor is further configured to:
determine the end of the spray duration period; and
transmit a second spray command to the plurality of valve control modules over the electrical conductors in order to open a second valve associated with a second spray nozzle.

39. The road spray system of claim 29 wherein the processor is further configured to activate a road sign associated with the road further in response to the degraded status.

40. The road spray system of claim 39 wherein the processor is further configured to activate the road sign by transmitting a road sign activation command over the electrical conductors.

41. The road spray system of claim 29 wherein the processor is further configured to transmit the spray command in response to receiving an input from an operator of the road spray system.

42. The road spray system of claim 41 wherein the input is received through one of the group of: a telephone connection, a web page, a network connection, a text message, and a wireless communications receiver.
